(19) United States
(12) Patent Application Publication
(10) Pub. No.: US 2011/0058362 A1
(43) Pub. Date: Mar. 10, 2011

(54) LED LIGHT LASER SIGHTING DEVICE

(75) Inventors: Jianhua Sun, Xi'an (CN); Kai Xu, Xi'an (CN); Xuewen Cheng, Xi'an (CN)

(73) Assignee: HUANIC CORPORATION, Xi'an, Shaanxi (CN)

(21) Appl. No.: 12/937,728

(22) PCT Filed: Nov. 16, 2009
(86) PCT No.: PCT/CN09/01266

§ 371 Date: Nov. 23, 2010

(30) Foreign Application Priority Data
Mar. 18, 2009 (CN) 200920032247.6

(51) Int. Cl. F21L 4/00

(52) U.S. Cl. 362/187; 362/157

(57) ABSTRACT

A LED light laser sighting device includes a body (16), a reflecting cavity (2) provided in both sides of said body (16), a rear cap (17), a LED light (4), a laser indicator (5) and a battery box (8) provided between said reflecting cavity (2) and said rear cap (17) for battery. A circuit board (11) is provided between said reflecting cavity (2) and said battery box (8). Said LED light (4) is provided in said reflecting cavity (2). Said laser indicator (5) is provided in said body (16). The central axis of said reflecting cavity (2) coincides with the central axis of said body (16). Said LED light (4), said laser indicator (5) are electrically connected to said circuit board (11). The sighting device has a laser indicator provided in the body of the LED illumination device, so as to integrate the function of illumination and sighting indication. The device has compact structure, small volume, low weight and is easily assembled, disassembled, carried and used.

### FIELD OF THE INVENTION

This invention relates to a laser sighting device, and in particularly to such a laser sighting device with an LED (Light Emitting Diode) light as can be rapidly mounted.

### BACKGROUND OF THE INVENTION

Sighting device is an important part of small arms. In the development of small arms, there have successively appeared various types of laser sighting devices, such as mechanical laser sighting device, optical laser sighting device and laser sighting device. Laser indicator sighting device finds wide use in fire arms, and especially it has unique advantages when it is used as short-distance rapid fire sight. On the other hand, LED, owing to its technology development, and especially owing to the sophistication of the production of the high power cold white LED, now features low energy-consumption and high brightness and thus instantly finds use in the arms for illumination at night.

In the development of such sighting devices of the arms, there is a trend towards making a combined sight by combining an LED light with an laser indicator. Nevertheless, such a combined sight of the prior art has three disadvantages. First, it has an incompact structure without an integral design, because the LED flashlight and the laser indicator are separate, i.e., being mounted on the arms separately from each other, or the laser indicator is attached to the LED flashlight. Second, it has a large volume and weight, rendering the arms including excessive accessories, requiring complex operation and presenting inconvenience in carrying. Third, it requires lengthy installation, which involves mounting it on a guide, usually by conventional screw-clamping with accessory tools, for example a wrench, thus necessitating provision of tools at all times and presenting inconvenience in practical use.

### CONTENTS OF THE INVENTION

In order to solve the technical problems stated in the Background of the Invention portion, the present invention provides a laser sighting device with an LED light, which has the advantage of allowing illumination and sighting at the same time.

The technical solution of the present invention is a laser sighting device with an LED light, comprising a body, a reflecting cavity and a rear cover disposed on two ends of the body respectively, a battery box disposed between the reflecting cavity and the rear cover for receiving batteries, and a circuit board disposed between the reflecting cavity and the battery box, characterized in that the sighting device is also provided with an LED light disposed within the reflecting cavity and a laser indicator disposed within the body, the central axis of the reflecting cavity and that of the body coincide, and the LED light and the laser indicator are electrically connected to the circuit board.

The LED light are disposed within the reflecting cavity on the end thereof adjacent to the circuit board along said central axis; the laser indicator is disposed on the LED light side; the reflecting cavity is provided with a light bore in its internal wall; and said light bore is disposed along an emitted light path of the laser indicator and extends along an emitted light path of the LED light toward the other end of the reflecting cavity.

The laser indicator is disposed within the reflecting cavity on the end thereof adjacent to the circuit board along said central axis, and the LED light are disposed within the reflecting cavity around the laser indicator.

The laser indicator is a focus-adjustable laser indicator.

The laser indicator is a red laser having a wavelength of 633-670 nm, a green laser having a wavelength of 532 nm, or an infrared laser having a wavelength of 780-1320 nm

Between the rear cover and the battery box for receiving the rear cover is disposed a seat, and a locking spring is disposed at a bottom portion of the body for locking the rear cover.

The sighting device further comprises a set of pin sockets disposed at a bottom portion of the seat and a set of spring pins disposed within the set of pin sockets; and the circuit board is electrically connected to the set of spring pins via the set of pin sockets.

A spring is disposed between the rear cover and the battery box; the spring is attached to the battery box; the rear cover is provided thereon with a mode selection switch handle and a power switch handle; the mode selection switch handle is electrically connected to the circuit board via the rear cover, the set of spring pins and the set of pin sockets; and the power switch handle is electrically connected to the battery box via the rear cover and the spring.

The body is streamlined on its upper surface, on which are disposed a horizontal adjusting threaded bore, a vertical adjusting threaded bore, screws disposed within the horizontal and vertical adjusting threaded bores, and springs to align the sighting device, the horizontal and vertical adjusting thread bores being disposed on one side of the laser indicator, and the springs being disposed on the opposite side of the laser indicator.

The sighting device further comprises a mounting means disposed on the bottom end of the body, the mounting means comprising a clamping handle having an eccentric nonlinear cam mechanism, a fixed jaw, a movable jaw, a first pressing spring, a second pressing spring, a first rod, a second rod, and a pin, the fixed and movable jaws and being disposed on the opposite sides of the lower end of the body respectively, the first rod being located at one end thereof outside of the fixed jaw and threadedly connected at the other end thereof to one end of the second rod, the second rod extending at the other end thereof to outside of the movable jaw and being connected to one end of the clamping handle via the pin, the clamping handle extending at the other end thereof to outside of the movable jaw and being rotatable around the pin to be located close to the outside of the body, the clamping handle being provided at one end thereof with an eccentric cam, the movable jaw being provided in the outside thereof corresponding to the eccentric cam with a recess for receiving the eccentric cam, and the first and second pressing springs being disposed between the movable jaw and the fixed jaw at two ends of the movable respectively.

The sighting device of the present invention has the effects of compact structure, small volume and weight, and ease of mounting, removal, carry and use, by disposing the laser indicator within the body of the LED illuminating device to achieve the integration of illumination with aiming indication.

### BRIEF DESCRIPTION OF DRAWINGS

FIG. 1 is a cross-sectional of a sighting device of the prevent invention;

FIG. 2 is perspective view of the sighting device of the prevent invention;

FIG. 3 is a view taken in the direction A of FIG. 2;

FIG. 4 is a view taken in the direction B of FIG. 2; and

FIG. 5 is a view taken in the direction C of FIG. 2.

### MODE OF CARRYING OUT THE INVENTION

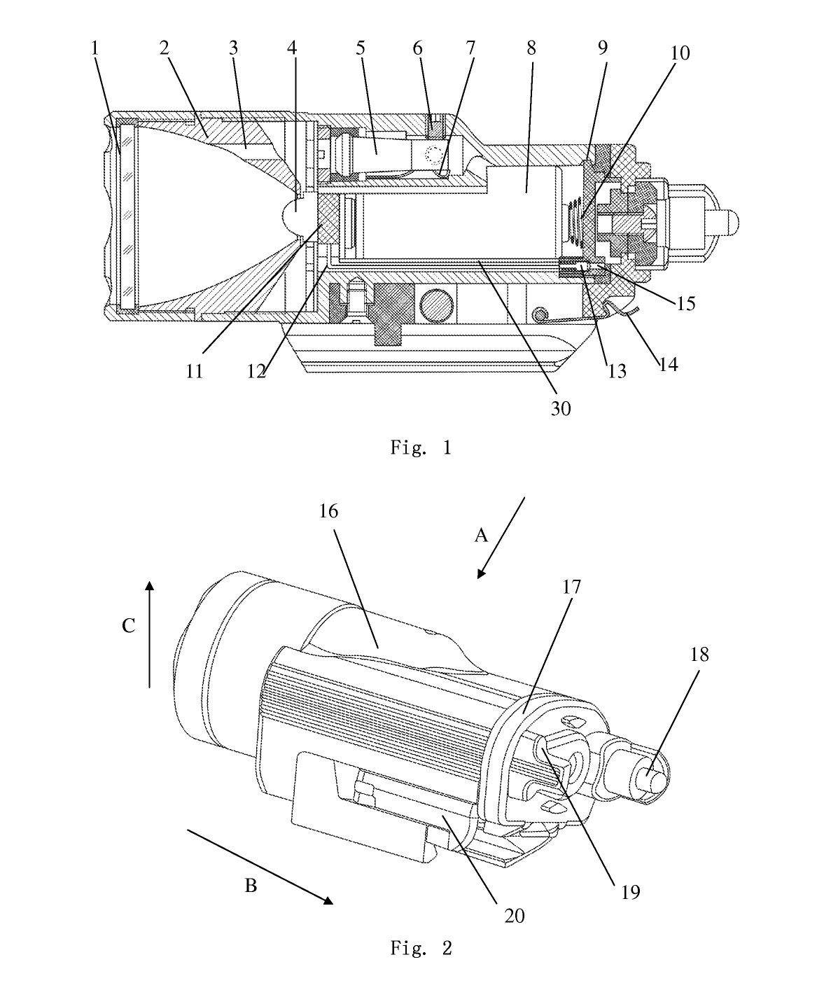

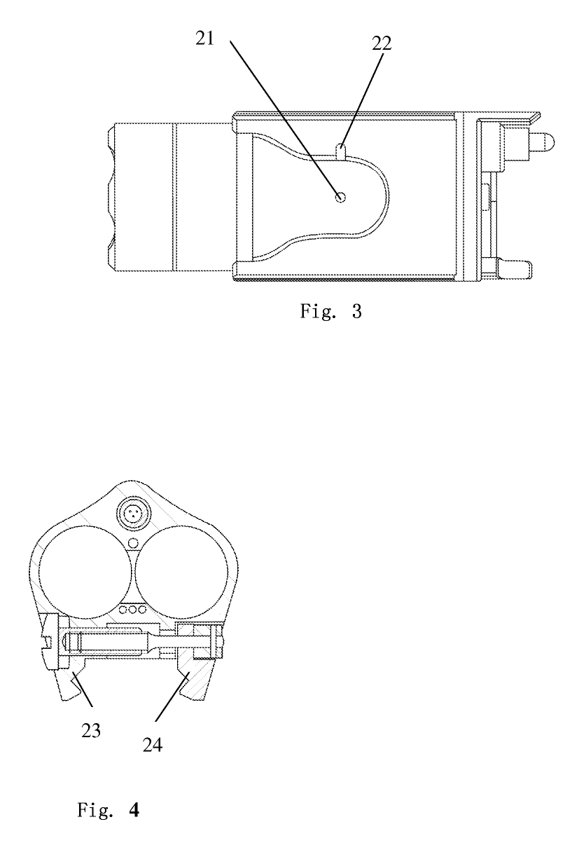

Referring to FIGS. 1, 2 and 3, a laser sighting device with an LED light according to the present invention, comprises a body 16, a reflecting cavity 2 and a rear cover 17 disposed on two ends of the body 16 respectively, and a battery box 8 disposed between the reflecting cavity 2 and the rear cover 17 for receiving batteries, a circuit board 11 being disposed between the reflecting cavity 2 and the battery box 8, characterized in that the sighting device is also provided with LED light 4 disposed within the reflecting cavity 2 and a laser indicator 5 disposed within the body 16, a central axis of the reflecting cavity 2 being aligned with that of the body 16, and both the LED light 4 and the laser indicator 5 being electrically connected to the circuit board 11.

In one embodiment, the LED light 4 are disposed along the central axis on the end of the reflecting cavity 2 adjacent to the circuit board 11; the laser indicator 5 is disposed on the LED light side; the reflecting cavity 2 is provided in its internal wall with a light bore 3; and said light bore 3 is disposed along an emitted light path of the laser indicator 5 and extends along an emitted light path of the LED light 4 toward the other end of the reflecting cavity 2.

The LED light 4 of the present invention comprise a high illumination white light semiconductor light emitting dioxide, thereby increasing illumination intensity of the sighting device.

In another embodiment, the laser indicator 5 may be disposed along the central axis within the reflecting cavity 2 on the end thereof adjacent to the circuit board 11; and the LED light 4 are disposed within the reflecting cavity 2 around the laser indicator 5.

The laser indicator 5 of the present invention may be a red laser having a wavelength of 633-670 nm, a green laser having a wavelength of 532 nm, or an infrared laser having a wavelength of 780-1320 nm; and the laser indicator 5 may emit collimated laser beam having a adjustable focus, thereby realizing the function of adjusting the focus of laser beam emitted by the laser depending on the range of arms.

A seat 9 is disposed between the rear cover 17 and battery box 8 of the sighting device for receiving the rear cover 17, and a locking spring 14 is disposed at a bottom portion of the body 16 for locking the rear cover 17.

The sighting device further comprises a set of pin sockets 15 disposed at a bottom portion of the seat 9 and a set of spring pins 13 disposed within the set of pin sockets 15; and the circuit board 11 is electrically connected to the set of spring pins 13 via the set of pin sockets 15.

The set of spring pins 13 of the prevent invention may comprise three spring pins; and the set of pin socket 15 may also comprise three pin sockets corresponding to the spring pins.

A first spring 10 is disposed between the rear cover 17 and battery box 8 of the sighting device; the first spring 10 is attached onto the battery box 8; the rear cover 17 is provided thereon with a mode selection switch handle 18 and a power switch handle 19; the mode selection switch handle is electrically connected to the circuit board 11 via the rear cover 17, the set of spring pins 13 and the set of pin sockets 15; and the power switch handle 19 is electrically connected to the battery box via the rear cover 17 and the first spring 10.

The sighting device further comprises a lead 12 for connecting the circuit board 11 to the set of pin sockets 15 and a lead channel within which the lead is installed, the lead channel extending from the set of pin sockets 15 to the lower end of the circuit board 11.

The reflecting cavity 2 of the present invention is a conical reflecting cavity, and may also be a parabolic reflecting cavity, so as to improve light reflectivity and further increase illumination intensity of the sighting device, as well as to save energy.

For the laser sighting device with LED light of the present invention, the body 16 is streamlined, and provided thereon with an aligning means, which comprises a vertical adjusting threaded bore 21 and a horizontal adjusting threaded bore 22; and under the action of a spring 7, the alignment of laser beam with trajectory can be obtained by adjusting screws 6 within the threaded bores.

The body 16 of the sighting device according to the present invention is streamlined on its upper surface, on which are disposed a horizontal adjusting threaded bore 22, a vertical adjusting threaded bore 21, screws 6 disposed within the horizontal and vertical adjusting threaded bores 22 and 21, and second springs 7 to align the sighting device, the horizontal and vertical adjusting thread bores 22 and 21 being disposed on one side of the laser indicator 5, and the second springs 7 being disposed on the opposite side of the laser indicator 5, so as to eliminate an adjusting gap and lock the sighting device.

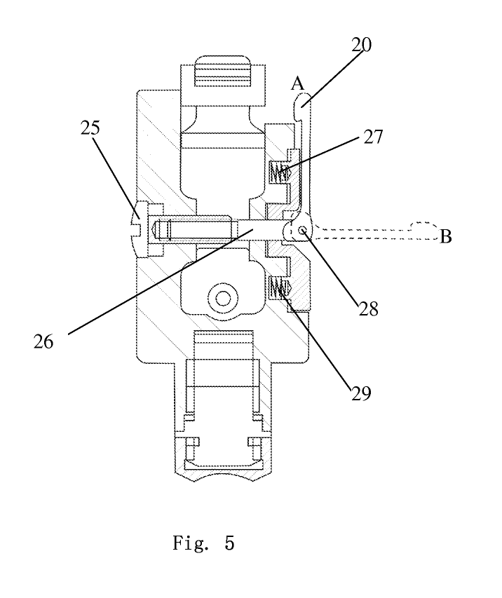

Referring to FIGS. 4 and 5, the sighting device of the present invention further comprises a mounting means disposed on the bottom end of the body 16, the mounting means comprising a clamping handle 20 having an eccentric nonlinear cam mechanism, a fixed jaw 23, a movable jaw 24, a first pressing spring 27, a second pressing spring 29, a first rod 25, a second rod 26, and a pin 28, the fixed and movable jaws 23 and 24 being disposed on the opposite sides of the lower end of the body 16 respectively, the first rod 25 being located at one end thereof outside of the fixed jaw 23 and threadedly connected at the other end thereof to one end of the second rod 26, and the second rod 26 being adjustable in length by rotating the first rod 25. The second rod 26 extends at the other end thereof to outside of the movable jaw 24 and is connected to one end of the clamping handle 20 via the pin 28; the clamping handle 20 extends at the other end thereof to outside of the movable jaw 24 and is rotatable around the pin 28 to be located close to the outside of the body 16; the clamping handle 20 is provided at one end thereof with an eccentric cam, which is also referred to as an eccentric nonlinear cam; the movable jaw 24 is provided in the outside thereof corresponding to the eccentric cam with a recess for receiving the eccentric cam; and the first and second pressing springs 27 and 29 are disposed between the movable jaw 24 and the fixed jaw 23 at two ends of the movable 24 respectively.

The mounting mean of the invention operates in the following manner: when the clamping handle 20 is rotated to the position B, the eccentric cam at the end of the clamping handle 20 connected to the second rod 26 moves to the lowest point, and the moveable jaw is released under the action of the first and second pressing springs 27 and 29, so that the sighting device can be mounted and removed easily; when the fixed and movable jaws 23 and 24 of the mounting means are mounted on the standard guide and the clamping handle 20 of the prevent invention is rotated to the position A, the eccentric cam at the end of the clamping handle 20 connected to the second rod 26 moves to the highest point and at the same time the clamping handle 20 is located close to the outside of the body 16, so as to compress the first and second pressing springs 27 and 29, thereby enabling the fixed and movable jaws 23 and 24 to be clamped on the standard guide, and to be in the self-locking state; and when the rod 25 is rotated, the length of the rod 26 is adjusted, so that the deference in the space between the fixed jaw 23 and the movable jaw 24, when clamped and released, is equal to the travel distance of the eccentric cam at the end of the clamping handler 20.

The mounting means may be integrated with the sighting device of the prevent invention, or may also be a separate component. The mounting means may be suited to optical sighting device, laser sighting device, holographic laser, and the like.

The power source of the prevent invention may be two Li battery each having a voltage of 3V, or may also be a high capacity alkaline battery. The power source is disposed within the battery box 8 of the body 16.

The circuit board 11 of the prevent invention is a drive circuit which drives the LED light 4 and the laser indicator 5.

1. A laser sighting device with LED light, comprising a body, a reflecting cavity and a rear cover disposed on two ends of the body respectively, and a battery box disposed between the reflecting cavity and the rear cover for receiving batteries, a circuit board being disposed between the reflecting cavity and the battery box, characterized in that the sighting device is also provided with LED light disposed within the reflecting cavity and a laser indicator disposed within the body, a central axis of the reflecting cavity being aligned with that of the body, and both the LED light and the laser indicator being electrically connected to the circuit board.

2. The sighting device according to claim 1, wherein the LED light are disposed along the central axis on the end of the reflecting cavity adjacent to the circuit board; the laser indicator is disposed on the LED light side; the reflecting cavity is provided in its internal wall with a light bore; and said light bore is disposed along an emitted light path of the laser indicator and extends along an emitted light path of the LED light toward the other end of the reflecting cavity.

3. The sighting device according to claim 1, wherein the laser indicator is disposed along the central axis within the reflecting cavity on the end thereof adjacent to the circuit board, and the LED light are disposed within the reflecting cavity around the laser indicator.

4. The sighting device according to claim 2, wherein the laser indicator is a focus adjustable laser indicator.

5. The sighting device according to claim 4, wherein the laser indicator is a red laser having a wavelength of 633-670 nm, a green laser having a wavelength of 532 nm, or an infrared laser having a wavelength of 780-1320 nm

6. The sighting device according to claim 5, wherein a seat is disposed between the rear cover and the battery box for receiving the rear cover, and a locking spring is disposed at a bottom portion of the body for locking the rear cover.

7. The sighting device according to claim 6, wherein the sighting device further comprises a set of pin sockets disposed at a bottom portion of the seat and a set of spring pins disposed within the set of pin sockets; and the circuit board is electrically connected to the set of spring pins via the set of pin sockets.

8. The sighting device according to claim 7, wherein a spring is disposed between the rear cover and the battery box; the spring is attached to the battery box; the rear cover is provided thereon with a mode selection switch handle and a power switch handle; the mode selection switch handle is electrically connected to the circuit board via the rear cover, the set of spring pins and the set of pin sockets; and the power switch handle is electrically connected to the battery box via the rear cover and the spring.

9. The sighting device according to claim 8, wherein the body is streamlined on its upper surface, on which are disposed a horizontal adjusting threaded bore, a vertical adjusting threaded bore, screws disposed within the horizontal and vertical adjusting threaded bores, and second springs to align the sighting device, the horizontal and vertical adjusting thread bores being disposed on one side of the laser indicator, and the second springs being disposed on the opposite side of the laser indicator.

10. The sighting device according to claim 9, wherein the sighting device further comprises a mounting means disposed on the bottom end of the body, the mounting means comprising a clamping handle having an eccentric nonlinear cam mechanism, a fixed jaw, a movable jaw, a first pressing spring, a second pressing spring, a first rod, a second rod, and a pin, the fixed and movable jaws being disposed on the opposite sides of the lower end of the body respectively, the first rod being located at one end thereof outside of the fixed jaw and threadedly connected at the other end thereof to one end of the second rod, the second rod extending at the other end thereof to outside of the movable jaw and being connected to one end of the clamping handle via the pin, the clamping handle extending at the other end thereof to outside of the movable jaw and being rotatable around the pin to be located close to the outside of the body, the clamping handle being provided at one distal end thereof with an eccentric cam, the movable jaw being provided at the outside thereof corresponding to the eccentric cam with a recess for receiving the eccentric cam, and the first and second pressing springs being disposed between the movable jaw and the fixed jaw at two ends of the movable jaw respectively.

11. The sighting device according to claim 3, wherein the laser indicator is a focus adjustable laser indicator.

12. The sighting device according to claim 11, wherein the laser indicator is a red laser having a wavelength of 633-670 nm, a green laser having a wavelength of 532 nm, or an infrared laser having a wavelength of 780-1320 nm

13. The sighting device according to claim 12, wherein a seat is disposed between the rear cover and the battery box for receiving the rear cover, and a locking spring is disposed at a bottom portion of the body for locking the rear cover.

14. The sighting device according to claim 13, wherein the sighting device further comprises a set of pin sockets disposed at a bottom portion of the seat and a set of spring pins disposed within the set of pin sockets; and the circuit board is electrically connected to the set of spring pins via the set of pin sockets.

15. The sighting device according to claim 14, wherein a spring is disposed between the rear cover and the battery box; the spring is attached to the battery box; the rear cover is provided thereon with a mode selection switch handle and a power switch handle; the mode selection switch handle is electrically connected to the circuit board via the rear cover, the set of spring pins and the set of pin sockets; and the power switch handle is electrically connected to the battery box via the rear cover and the spring.

16. The sighting device according to claim 15, wherein the body is streamlined on its upper surface, on which are disposed a horizontal adjusting threaded bore, a vertical adjusting threaded bore, screws disposed within the horizontal and vertical adjusting threaded bores, and second springs to align the sighting device, the horizontal and vertical adjusting thread bores being disposed on one side of the laser indicator, and the second springs being disposed on the opposite side of the laser indicator.

17. The sighting device according to claim 16, wherein the sighting device further comprises a mounting means disposed on the bottom end of the body, the mounting means comprising a clamping handle having an eccentric nonlinear cam mechanism, a fixed jaw, a movable jaw, a first pressing spring, a second pressing spring, a first rod, a second rod, and a pin, the fixed and movable jaws being disposed on the opposite sides of the lower end of the body respectively, the first rod being located at one end thereof outside of the fixed jaw and threadedly connected at the other end thereof to one end of the second rod, the second rod extending at the other end thereof to outside of the movable jaw and being connected to one end of the clamping handle via the pin, the clamping handle extending at the other end thereof to outside of the movable jaw and being rotatable around the pin to be located close to the outside of the body, the clamping handle being provided at one distal end thereof with an eccentric cam, the movable jaw being provided at the outside thereof corresponding to the eccentric cam with a recess for receiving the eccentric cam, and the first and second pressing springs being disposed between the movable jaw and the fixed jaw at two ends of the movable jaw respectively.
